(19) United States
(12) Patent Application Publication
(10) Pub. No.: US 2014/0008147 A1
(43) Pub. Date: Jan. 9, 2014

(54) Harness Safety System

(71) Applicants: Karl Jones, Wiltshire (GB); Owain Jones, Wiltshire (GB)

(72) Inventors: Karl Jones, Wiltshire (GB); Owain Jones, Wiltshire (GB)

(73) Assignee: Latchways PLC, Wiltshire (GB)

(21) Appl. No.: 14/006,704

(22) PCT Filed: Mar. 26, 2012
(86) PCT No.: PCT/GB2012/050662

§ 371 Date: Sep. 23, 2013

(30) Foreign Application Priority Data
Mar. 25, 2011 (GB) 1105043.2

(51) Int. Cl. A62B 35/04

(52) U.S. Cl. CPC A62B 35/04
USPC 182/3

(57) ABSTRACT

A harness safety system comprising energy absorbing material that exhibits a change in physical properties at different applied strain rates. Typically, as a result of a sudden impact or applied stress or pressure event the material becomes substantially rigid, changing to a less rigid, more resilient, relaxed or conformable state after a elapsing of a time period following the sudden impact or applied stress or pressure event.

### CROSS-REFERENCE TO RELATED APPLICATIONS

This application claims priority from PCT/GB/2012/050662 filed on Mar. 26, 2012, and GB 1105043.2 filed on Mar. 25, 2011, all of which are hereby incorporated by reference in their entireties.

### BACKGROUND

1. Field

The present invention relates to a harness safety system and in particular to such a system arranged to minimise injury in the event of a fall arrest situation.

2. State of the Art

Suspension trauma, also known as harness hang syndrome (HHS), is an effect which occurs when the human body is held upright without any movement for a period of time. If the person is strapped into a harness or tied to an upright object they will eventually suffer the Central Ischemic Response (commonly known as fainting). If one faints but remains vertical, one risks death due to one's brain not receiving the oxygen it requires. People at risk of suspension trauma include people using industrial harnesses (fall arrest systems, abseiling systems), people using harnesses for sporting purposes (caving, climbing, parachuting, etc).

The effect is exacerbated and severe injury and even death can result from the instantaneous tightening of the harness in fall arrest situations as the fall victims weight is taken by a safety line attached to the harness. The harness tightens typically across the fall victim's chest and groin area cutting into the flesh and preventing blood circulation.

An improved arrangement has now been devised.

### SUMMARY

According to the present invention, there is provided a harness safety system comprising energy absorbing material that exhibits a change in physical properties at different applied strain rates.

Shear thickening materials or dilatants exhibit a change in physical properties at different applied strain rates, and are referred to in the prior art such as EP1458254. Such materials may viscously flow at low rates of deformation but at an elevated rate of deformation undergo a substantial increase in viscosity. EP1458254 describes how a self supporting composite having such properties may be arrived at. WO2005/000966 also describes energy absorbing composite polymers having such or similar properties.

It is preferred that the harness is provided with one or more protection zones of the energy absorbing material.

As a potential alternative the harness may incorporate the energy absorbing material substantially throughout.

It is preferred that the energy absorbing material is more conformable, relaxed or resilient at lower applied strain rates and less conformable, relaxed or resilient at higher applied strain rates (that is, it is preferred that the energy absorbing material is more rigid at higher applied strain rates).

Beneficially, as a result of a sudden impact or applied stress the material becomes substantially rigid.

It is preferred that, as a result of a sudden impact or applied stress or pressure event the energy absorbing material becomes substantially rigid, changing to a less rigid, more resilient, relaxed or conformable state after a elapsing of a time period following the sudden impact or applied stress or pressure event. This feature is highly beneficial to reduce the seriousness of after-effects following a fall arrest event because it minimises the restriction of blood flow when a person remains suspended following the fall arrest event. The beneficial effects in this respect are neither acknowledged or suggested in the prior art.

In one embodiment it may be preferred that the protection zone comprises a pad of the energy absorbing material secured to the harness, for example secured to a strap or webbing part of the harness.

In one embodiment, it may be preferred that the pad comprises a self supporting energy absorbing composite. Such self supporting energy absorbing composites are disclosed in, for example WO2005/000966 and/or EP1458254.

It is preferred that the energy absorbing material is provided at the leg loop strap of the harness to protect the leg or groin area of the user.

Additionally or alternatively, the energy absorbing material may provided at the chest strap of the harness to protect the chest of the user.

The invention will now be further described in a specific embodiment, by way of example only, and with reference to the accompanying drawings.

### BRIEF DESCRIPTION OF THE DRAWINGS

FIG. 1 is a schematic side view of a prior art harness safety system;

FIG. 2 is a schematic view of the system of FIG. 1 when the fall of a user has been arrested;

FIG. 3 is a frontal view of the situation represented in FIG. 2;

FIG. 4 is a schematic side view of a harness safety system in accordance with the invention;

FIG. 5 is a schematic view of the system of FIG. 4 in the instant following the arrest of a fall of a user;

FIG. 6 is a frontal view of the situation represented in FIG. 5;

FIG. 7 is a schematic view of the system of FIG. 4 following the elapse of a short time period following the arrest of the users fall;

FIG. 8 is a schematic sectional view of the webbing of the harness material in an embodiment in which the energy absorber material is positioned internally of the webbing straps.

FIG. 9 is a sectional view of the arrangement of FIG. 8 in which the webbing has been flattened.

### DETAILED DESCRIPTION OF THE PREFERRED EMBODIMENTS

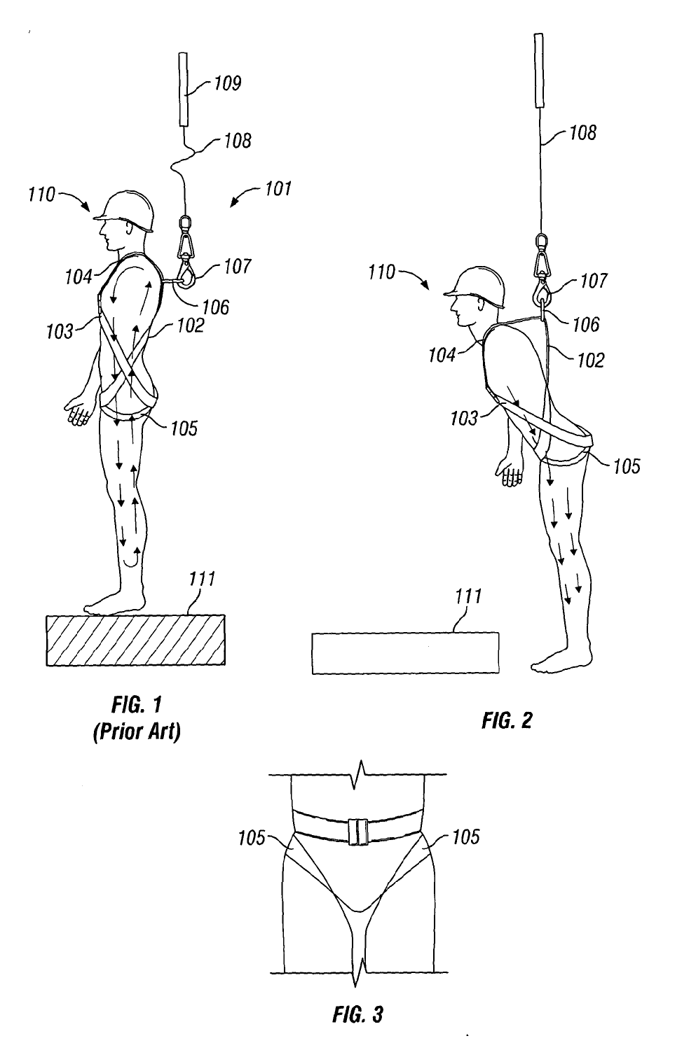

Referring to the drawings, and initially to FIGS. 1 to 3, there is shown a prior art harness safety system 101 in which a strap harness 102 is secured around a users chest by means of chest and shoulder straps 103,104 and also around the users groin by means of leg loop straps 105. The harness 102 has a D-ring connector 106 which is connected by means of a Karabiner 107 to a safety line 108 and a safety line anchor 109.

In FIG. 1, the harness is shown strapped to the person 110 standing on a support platform 111 and in which the safety line is not in maximum tension (because no fall has been arrested).

In the situation shown in FIG. 2, the person 110 has fallen from support platform 111 and the fall has been arrested by the safety line 108 which is now in tension. At the moment the fall is arrested, very large impulse forces are transmitted by the harness to the user. Particularly the chest and shoulder straps 103,104 and leg loops 105 cut into and tighten around the flesh of the user making breathing difficult and cutting off circulation.

Typically in such circumstances following a fall arrest event and in which the person remains suspended by the safety line 108 attached to the harness, blood pumped into the legs is prevented from returning to the heart by means of the leg loops 105 cutting into the groin. Additionally, the leg loops can cut the flesh of the user and cause serious injury. This is shown in FIG. 3 in which the leg loops 105 can be seen as cutting into the groin area preventing blood circulation. As shown in FIG. 1, before the harness straps tighten around the user (as a result of a fall for example) blood can circulate throughout the body.

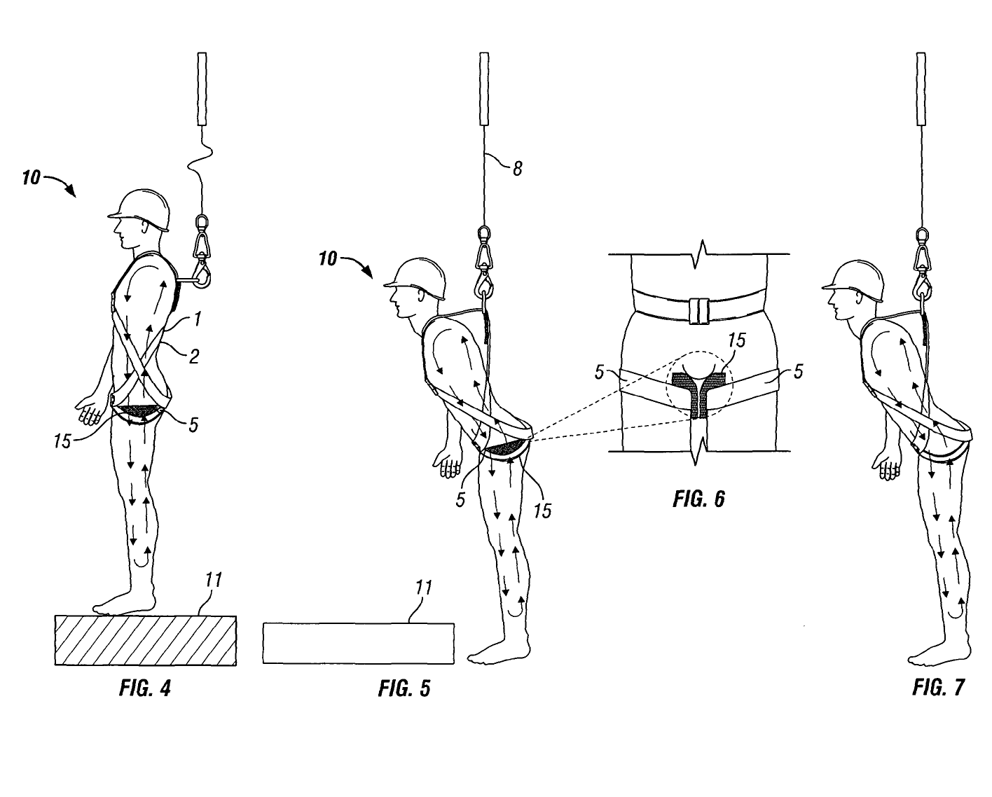

As shown now in FIGS. 4 to 7, and in accordance with the invention, the harness safety system 1 includes one or more protection zones forming part of the harness system. In the arrangement shown, the harness is provided with a groin strap protection zone comprising protection pads 15, secured to respective leg straps 5 to be positioned intermediately between the leg straps 5 and the groin/leg area of the user.

Importantly, the material of the protection zone pads 15 is formed of a particular material that has certain beneficial characteristics. In the event of an impulse load being applied to the pads 15 (for example in the circumstances of a fall arrest situation), the pads physical characteristics alter from a resilient or flexible conformal state to a more hardened or rigid material condition. The change of physical condition of the pads ensure that the impulse load applied via the harness straps is spread over a greater area and also that the harness is prevented from cutting into the body of the user thereby causing trauma damage or cutting off circulation to the user.

It is important that the pads are conformable to some degree prior to the hardening effect caused by the impulse force acting on them to change them to the hardened state. It is furthermore highly desirable that following the impulse event and the change to the hardened state, the material of the pads will subsequently return to the conformable (flexible and resilient) state. This is highly desirable because it ensures that any restriction to the circulation following the fall arrest event is minimised.

Materials that can be used for the protection zone pads are known in the prior art. For example, and particularly, as disclosed in WO2005/000966 and EP145825 materials described as composite materials which are elastic and exhibit resistive load under deformation which increases with the rate of deformation are described. Such materials are commercially available under the trade name d30 (registered trademark). As described in WO2005/000966 such composite materials are resistant to permanent set under various types of loading (compression, tension, sheer etc) and can revert to the flexible/resilient state following the energy/impact/impulse absorbing event. The material may be described in general terms as energy absorbing material that exhibits a change in physical properties at different applied strain rates.

Shear thickening materials or dilatants exhibit a change in physical properties at different applied strain rates, and are referred to in the prior art such as EP1458254. Such materials may viscously flow at low rates of deformation but at an elevated rate of deformation undergo a substantial increase in viscosity. EP1458254 describes how a self supporting composite having such properties may be arrived at. WO2005/000966 also describes energy absorbing composite polymers having such or similar properties.

WO2005/000966 and EP1832186 describe the use of a self-supporting energy absorbing composite in which a closed-cell foam matrix is used. However, certain benefits can also be obtained using other prior art described in EP1832186 in which the energy absorbing materials are not self-supporting but rather comprise, for example, dispersion of solid particles in a viscous fluid which is contained in an envelope. Important features in respect of the present invention are that the protective zone material is initially provided in a flexible/resilient/conformable condition, subsequently changing physical properties to a hardened condition upon application of an impulse force and subsequently returning to a resilient/conformable physical state.

As shown in the drawings, the protection zone pads 15 are secured to the leg loop straps 5 of the harness 2. In the situation shown in FIG. 4, the user is standing on platform 11 and the harness hangs relatively loosely about the body of the user 10. In the situation shown in FIG. 5, the user 10 has fallen from the support platform 11 and the safety line 8 has arrested the fall and the harness straps tightened around the body including tightening of the leg loop straps 5 around the groin area of the user. In this situation, the impulse force applied by the tightening of the straps 5 and compression of the protection zone pads 15 causes the physical state to alter in accordance with the materials described in, for example, WO2005/000966 and EP1832186 to the altered energy-absorbing state. In this state, the load applied by the tightening straps 5 is spread and the harness does not tighten into the groin area to cause significant damage or inhibition of blood circulation as in the prior art arrangement as shown in FIG. 3.

Importantly, following a short time period, the material of the protection zone pads 15 returns to the flexible/resilient/conformable condition further enhancing the ability of the blood to circulate in the user's body (particularly to and from the user's legs). Therefore, in accordance with an important aspect of the invention, as a result of a sudden impact or applied stress or pressure event the energy absorbing material becomes substantially rigid, changing to a less rigid, more resilient, relaxed or conformable state after a elapsing of a time period following the sudden impact or applied stress or pressure event. This feature is highly beneficial to reduce the seriousness of after-effects following a fall arrest event because it minimises the restriction of blood flow when a person remains suspended following the fall arrest event. The beneficial effects in this respect are neither acknowledged or suggested in the prior art.

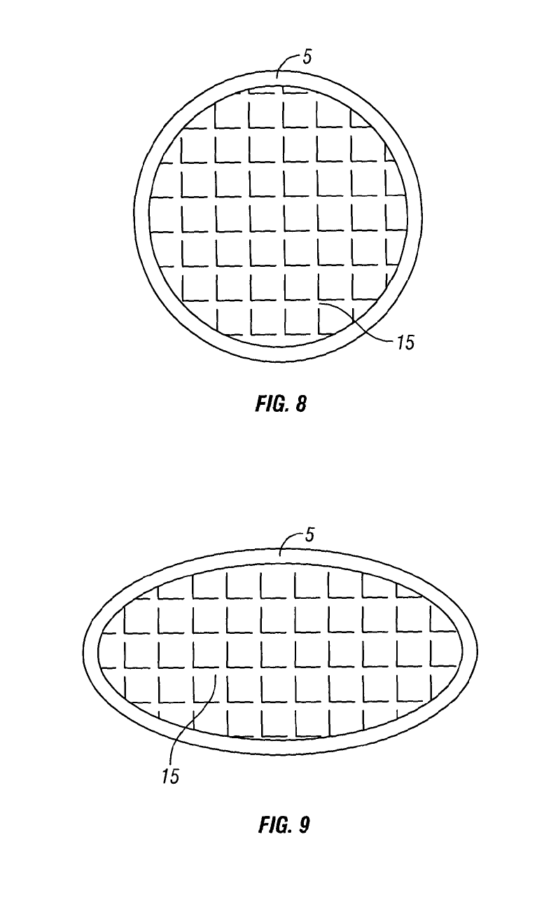

The invention has primarily been described in which protection zone pads 5 are secured to webbing or strap portions of the harness. In alternative embodiment substantially the entire harness, or webbing or strap lengths may be formed of the energy absorbent material. FIGS. 8 and 9 show an embodiment, for example in which the energy absorbent pad 15 is formed by extruding the energy absorbing material into tubular webbing straps 5. The tubular straps 5 may then be flattened to the configuration shown in FIG. 9.

There have been described and illustrated herein several embodiments of a safety harness system and corresponding method of operation. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A harness safety system comprising energy absorbing material that exhibits a change in physical properties at different applied strain rates.

2. A harness safety system according to claim 1, wherein the harness is provided with one or more protection zones of the energy absorbing material.

3. A harness safety system according to claim 1, wherein the energy absorbing material is more conformable, relaxed or resilient at lower applied strain rates and less conformable, relaxed or resilient at higher applied strain rates.

4. A harness safety system according to claim 1, wherein as a result of a sudden impact or applied stress the material becomes substantially rigid.

5. A harness safety system according to claim 1, wherein as a result of a sudden impact or applied stress or pressure event the material becomes substantially rigid, changing to a less rigid, more resilient, relaxed or conformable state after a elapsing of a time period following the sudden impact or applied stress or pressure event.

6. A harness safety system according to claim 1, wherein the protection zone comprises a pad of the energy absorbing material secured to the harness.

7. A harness safety system according to claim 6, wherein the pad comprises a self supporting energy absorbing composite.

8. A harness safety system according to claim 1, wherein the energy absorbing material is provided at the leg loop strap of the harness to protect the leg or groin area of the user.

9. A harness safety system according to claim 1, wherein the energy absorbing material is provided at the chest strap of the harness to protect the chest of the user.
